(19) United States
(12) Patent Application Publication
(10) Pub. No.: US 2026/0236375 A1
(43) Pub. Date: Aug. 13, 2026

(54) SYSTEM AND METHOD FOR SOFTWARE TESTING

(71) Applicant: The Toronto-Dominion Bank, Toronto (CA)

(72) Inventors: Nandhini SHANKAR, Mississauga (CA); Babatunde Adeyinka KASSIM, Mississauga (CA); Atul BHATNAGAR, Mississauga (CA); Mark Amar Mezher FALZON, Milton (CA); Chi King Bertha CHAN-LO, Markham (CA); Tarun SACHDEVA, Mississauga (CA); Shlok BARWE, Pune (IN); Shreyans SETHIA, Whitby (CA)

(21) Appl. No.: 19/050,469

(22) Filed: Feb. 11, 2025

(51) Int. Cl. G06F 11/3668

(52) U.S. Cl. CPC G06F 11/3684; G06F 11/3688; G06F 11/3696

(57) ABSTRACT

Computing platforms, methods, and storage media for software testing are disclosed. Exemplary implementations may: receive a configuration file for testing a browser-based application, the configuration file comprising browser configuration data associated with a plurality of browsers in relation to which the browser-based application is to be tested; generate a plurality of browser-specific feature files corresponding to a plurality of test scenarios for the testing of the browser-based application, each of the plurality of browser-specific feature files comprising browser-specific parameters based on the browser configuration data; generate a plurality of runner files associated with the plurality of browser-specific feature files; and automatically perform parallel testing of the plurality of feature files and the plurality of runner files in the plurality of browsers.

### FIELD

The present disclosure relates to computing and testing, including but not limited to computing platforms, methods, and storage media for software testing.

### BACKGROUND

In software development, it is often necessary to perform software testing. One type of software testing is regression testing, which involves going back or regressing to existing software code to ensure that the code still functions as expected after a change is introduced in the software application.

Software testing may involve testing of different versions of a software application, or app, running on one or more different operating systems. In the case of a browser-based application, software testing may involve testing the browser-based application in a plurality of browsers, also possibly on a plurality of operating systems, to ensure proper operation of the application for the largest number of users. While it can be beneficial to automate aspects of such testing, current approaches for software testing involve limitations in terms of automation when there is a need to test on multiple browsers.

Improvements in approaches for software testing are desirable.

### BRIEF DESCRIPTION OF THE DRAWINGS

Embodiments of the present disclosure will now be described, by way of example only, with reference to the attached Figures.

FIG. 1 illustrates a system configured for software testing, in accordance with one or more embodiments.

FIG. 2 illustrates another system configured for software testing, in accordance with one or more embodiments.

FIG. 3 illustrates a method for software testing, in accordance with one or more embodiments.

FIG. 4 illustrates a method for software testing with example outputs, in accordance with one or more embodiments.

FIG. 5 illustrates example code for a feature file including two scenarios for test cases, in accordance with one or more embodiments.

FIG. 6 illustrates example code for a first single-scenario feature file including browser-specific parameters, in accordance with one or more embodiments.

FIG. 7 is a project object model file illustrating browser configuration data, in accordance with one or more embodiments.

### DETAILED DESCRIPTION

Computing platforms, methods, and storage media for software testing are disclosed. Exemplary implementations may: receive a configuration file for testing a browser-based application, the configuration file comprising browser configuration data associated with a plurality of browsers in relation to which the browser-based application is to be tested; generate a plurality of browser-specific feature files corresponding to a plurality of test scenarios for the testing of the browser-based application, each of the plurality of browser-specific feature files comprising browser-specific parameters based on the browser configuration data; generate a plurality of runner files associated with the plurality of browser-specific feature files; and automatically perform parallel testing of the plurality of feature files and the plurality of runner files in the plurality of browsers.

The present disclosure provides a platform to automate concurrent testing of a browser application in parallel on a plurality of browsers.

Embodiments of the present disclosure provide a system and method to automate browser testing, for example regression testing, so that the testing is performed cross-browser and in parallel. Embodiments of the present disclosure leverage a plugin to split an original feature file into a plurality of feature files for different browser testing scenarios and to include a browser name tag. The different browsers are automatically launched as part of execution of the tests in parallel based on the feature file. The browser name tag may be used for data reporting on the execution of the testing, enabling the tests to be viewed and analyzed in a single platform and on a per-browser basis. Performing automated cross-browser testing in parallel saves time compared to performing the testing in series, and the automation saves time otherwise spent by quality engineers performing tasks.

One aspect of the present disclosure relates to a computing platform configured for software testing. The computing platform may include a non-transient computer-readable storage medium having executable instructions embodied thereon. The computing platform may include one or more hardware processors configured to execute the instructions. The processor(s) may execute the instructions to receive a configuration file for testing a browser-based application. The configuration file may include browser configuration data associated with a plurality of browsers in relation to which the browser-based application is to be tested. The processor(s) may execute the instructions to generate a plurality of browser-specific feature files corresponding to a plurality of test scenarios for the testing of the browser-based application. Each of the plurality of browser-specific feature files may include browser-specific parameters based on the browser configuration data. The processor(s) may execute the instructions to generate a plurality of runner files associated with the plurality of browser-specific feature files. The processor(s) may execute the instructions to automatically perform parallel testing of the plurality of feature files and the plurality of runner files in the plurality of browsers.

Another aspect of the present disclosure relates to a method for software testing. The method may include receiving a configuration file for testing a browser-based application. The configuration file may include browser configuration data associated with a plurality of browsers in relation to which the browser-based application is to be tested. The method may include generating a plurality of browser-specific feature files corresponding to a plurality of test scenarios for the testing of the browser-based application. Each of the plurality of browser-specific feature files may include browser-specific parameters based on the browser configuration data. The method may include generating a plurality of runner files associated with the plurality of browser-specific feature files. The method may include automatically performing parallel testing of the plurality of feature files and the plurality of runner files in the plurality of browsers.

Yet another aspect of the present disclosure relates to a non-transient computer-readable storage medium having instructions embodied thereon, the instructions being executable by one or more processors to perform a method for software testing. The method may include receiving a configuration file for testing a browser-based application, the configuration file comprising browser configuration data associated with a plurality of browsers in relation to which the browser-based application is to be tested. The method may include generating a plurality of browser-specific feature files corresponding to a plurality of test scenarios for the testing of the browser-based application, each of the plurality of browser-specific feature files comprising browser-specific parameters based on the browser configuration data. The method may include generating a plurality of runner files associated with the plurality of browser-specific feature files. The method may include automatically performing parallel testing of the plurality of feature files and the plurality of runner files in the plurality of browsers.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

Certain terms used in this application and their meaning as used in this context are set forth in the description below. To the extent a term used herein is not defined, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

Embodiments of the present disclosure provide a system configured to automatically generate multiple feature files and corresponding runner files, or features and runners, to run cross-browser tests in parallel in the same session, for example using a plugin such as a modified Cucuable plugin.

Cucumber is a software tool for behavior-driven development (BDD) that may be used for software development and testing. Cucuable is a plugin for Cucumber scenarios used for parallel test runs. Feature files and runner files may be used in a Cucumber implementation. A feature file allows a user to express technical terminology in English language (as opposed to software code), and may be used to list scenarios. A corresponding runner file may comprise the technical interpretation of the scenarios in the feature file. According to a known approach, if there are multiple scenarios in a single file, the Cucuable plugin may be used to generate the multiple scenarios into single-scenario files, and generate corresponding runners for each single scenario feature file.

According to known approaches, users have to execute an automated regression suite across browsers. Currently no test automation framework supports cross browser execution in parallel at the same time. This results in triggering of multiple executions targeting different browsers sequentially, which is very time-consuming in terms of tasks and results in loss of productivity for quality engineers running the tests.

Current approaches can only run a test on one browser at a time. Embodiments of the present disclosure enable running of automation testing on multiple browsers, for example on up to 20 different browsers. The browsers may be desktop browsers or mobile browsers, such as Chrome, Firefox, Safari, Edge, etc. Current approaches may use different third party libraries, which do not allow cross-browser testing as a single unit. Existing approaches need to be stitched together, causing problems for automation.

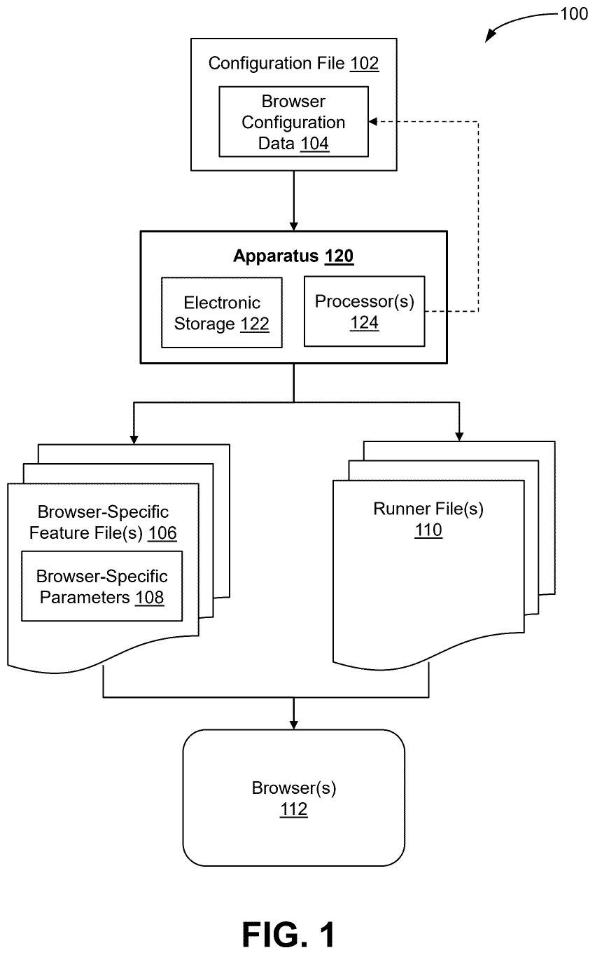

FIG. 1 illustrates a system 100 configured for software testing, in accordance with one or more embodiments. The system 100 comprises an apparatus 120 which may include electronic storage 122 such as a non-transient computer-readable storage medium having executable instructions embodied thereon. The apparatus 120 may include one or more hardware processors 124 configured to execute the instructions. The processor(s) may execute the instructions to receive a configuration file 102 for testing a browser-based application.

The configuration file 102 may include browser configuration data 104 associated with a plurality of browsers 112 in relation to which the browser-based application is to be tested. In an example embodiment, the configuration file may be modified by the apparatus 120 to include the browser configuration data 104. The browser configuration data 104 may comprise one or more of browser name, browser version, browser values and generation type values.

A plugin may be used to create the configuration file 102. Embodiments of the present disclosure provide a technical solution to create or modify a plugin to split scenarios in a feature file based on browser type. In an example implementation, the apparatus 120 may obtain the browser configuration data 104 at the time of execution, for example from a computing device or database associated with a user. The apparatus 120 may be configured to modify the plugin to add the browser configuration data 104 to the configuration file 102, where the configuration file 102 did not originally include any browser configuration data. Based on these provided values, cross-parallelization may be achieved by splitting all of the available scenarios into a single feature file differentiated on the basis of browser configuration data, and enabling a new software application or framework to launch cross-browser in parallel at the same time.

The processor(s) 124 may execute the instructions to generate a plurality of browser-specific feature files 106 corresponding to a plurality of test scenarios for the testing of the browser-based application. Each of the plurality of browser-specific feature files 106 may include browser-specific parameters 108 based on the browser configuration data. The processor(s) 124 may execute the instructions to generate a plurality of runner files 110 associated with the plurality of browser-specific feature files 106. The processor(s) 124 may execute the instructions to automatically perform parallel testing of the plurality of feature files and the plurality of runner files in the plurality of browsers 112.

Consider a scenario in which a company deploying software applications may have a number of different applications, each of which need continuous testing. The system 100 may be used to test multiple browsers at the same time. While existing solutions may permit running parallel scripts in the same browser at the same time, the system 100 may advantageously run parallel tests in different browsers, which is not currently possible with known approaches.

The system 100 may be configured to run multiple concurrent sessions with different browsers for each session. The system 100 may employ an open-source plugin to split scenario files. The system 100 may be configured to modify the open-source plugin to run the plugin with browser configuration data such as the tagged name of the browser(s) to be tested. For example, the system 100 may modify the open-source solution to tag the configuration file 102 with browser configuration data 104, for example including a particular browser name. In an implementation, the apparatus 120 may be configured to perform a browser validation, for example by determining whether a detected browser provides an exact match of browser version. The system 100 may be configured to handle the logic based on the browser configuration data which may include a browser tag. For example, with a Chrome tag, the apparatus 120 may be configured to perform automation that opens the Chrome browser.

The system 100 may be configured to customize a plugin to run on multiple browsers at the same time. For example, the apparatus 102 may be configured to add browser configuration data 104, which was not present earlier, to the configuration file 102. In an example embodiment, the system 100 is configured to add browser tagging, where an existing approach may not have had the ability to tag the name of the browser before.

Consider a specific example scenario in which the system 100 is used to run a test case on Edge and Chrome browsers. According to an example embodiment, the system 100 and for example the apparatus 120 may be configured to use a plugin to go through the browser configuration data 104, which may include browser tags, determine that the Chrome and Edge browsers are mentioned or tagged, and create two copies of same scenario with the respective browser Chrome and Edge browser name. The system 100 may be configured to create copies, and when the system sees the copies of test cases, the apparatus 120 may be configured to read the browser configuration data 104, open the specific browser tag and open different instances of a custom test case in same browser. For example, the apparatus 120 may use a plugin to split the feature file into 2 different copies, and based on the tag name, it will launch or invoke the right browser.

A known open-source plugin may be set up to run, in parallel, in a single browser at a time. Such a known approach requires using one browser at a time, and multiple sessions. Using a system 100 according to one or more embodiments, different types of browsers can be opened concurrently, and different sessions can be run in parallel in different browsers. This can be achieved because the system 100 includes or adds browser configuration data 104 in the configuration file, for example in the source code of the plugin, and the apparatus 120 may be configured to include logic to handle those configurations in the test. In an example implementation, the system 100 or the apparatus 120 comprises browser configuration data 104 that comprises 3 fields in the plugin: browser information, browser name (which may be obtained by providing a prompt to a user), and an exact/closest match of the browser (to perform browser validation). The system 100 or the apparatus 120 may then modify existing logic so that it tags those sessions.

The browser configuration data 104 may include browser name and generation type. The system 100 may modify the code to read these two properties. On the basis of the input or configuration file 102 that a user device may provide, during runtime the system 100 may tag the browser names in the scenarios, where the browser configuration data 104 comprises the browser name.

An original configuration file 102 may not include browser configuration data 104, and the system 100 may be configured to use a modified plugin to tag/add the browser configuration data 104, for example including browser name. The system 100 may be configured to read the name of the browser and to launch the browser in parallel. In an example implementation, a scripting tool may be configured to open the browser itself to run the test properly in the plurality of browsers.

The system 100 may be configured to use a plugin to enable parallel execution of browser tests on different browsers 112, when the plugin was not intended for that purpose. Embodiments of the present disclosure provide a single end-to-end solution that enables running the scripts in parallel and enables reporting as well, which will be described later. If a second browser name is added in the code, the system 100 may be configured to launch two browsers to run test scripts in parallel. The system 100 may be configured to split a scenario into two different browser-specific feature files 106, one for Chrome and one for Edge, and to generate corresponding runner files 110. The system 100 may be configured to launch the browsers 112 automatically as part of the testing, and open multiple versions of each browser.

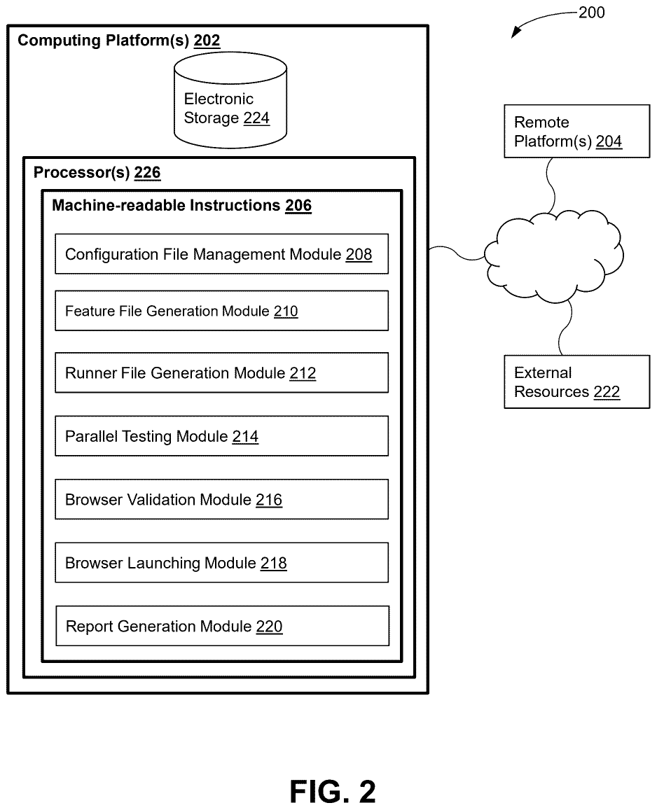

FIG. 2 illustrates a system 200 configured for software testing, in accordance with one or more embodiments. In some embodiments, system 200 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of configuration file management module 208, feature file generation module 210, runner file generation module 212, parallel testing module 214, browser validation module 216, browser launching module 218, report generation module 220, and/or other instruction modules.

Configuration file management module 208 may be configured to receive a configuration file for testing a browser-based application. The configuration file may include browser configuration data associated with a plurality of browsers in relation to which the browser-based application is to be tested. Configuration file management module 208 may be configured to generate the configuration file by obtaining and modifying a non-browser-specific configuration file to include the browser configuration data.

Feature file generation module 210 may be configured to generate a plurality of browser-specific feature files corresponding to a plurality of test scenarios for the testing of the browser-based application. Each of the plurality of browser-specific feature files may include browser-specific parameters based on the browser configuration data. Feature file generation module 210 may be configured to generate the browser-specific feature files by splitting, using a plugin, an original feature file into the same number of browser-specific feature files as the number of tagged browsers to be tested. The browser-specific feature files may be generated based on the browser configuration data including a browser name and a browser test generation type.

Runner file generation module 212 may be configured to generate a plurality of runner files associated with the plurality of browser-specific feature files, which may be generated by feature file generation module 210.

Parallel testing module 214 may be configured to automatically perform parallel testing of the plurality of feature files and the plurality of runner files in the plurality of browsers. Parallel testing module 214 may be configured to cause launching of each of the plurality of browsers in order to automatically perform parallel testing of the plurality of feature files and the plurality of runner files in the plurality of browsers.

Configuration file management module 208 may be configured to generate the plurality of browser-specific feature files by splitting, using a plugin, an original feature file into the same number of browser-specific feature files as the number of tagged browsers to be tested.

Browser validation module 216 may be configured to validate a selected browser when the selected browser has a matching browser name and a nonidentical browser version compared to the browser-specific parameters of at least one of the plurality of browser-specific feature files. For example, if browser configuration data refers to Chrome version 129, and the system has access to Chrome version 125, the browser validation module may be configured to validate the Chrome version 129 browser when the selected browser has a matching browser name to the available Chrome version 125 and a nonidentical browser version.

In an example embodiment, a browser validation file or browser validation database may store data corresponding to conditions that would cause a browser validation module to validate or not validate a selected browser. For example, a browser validation file may specify that if a selected browser is within a threshold number of versions of a browser name and version specified in the browser configuration data, the browser validation module 216 will validate the selected browser. The threshold number of versions may be different for different browser names, and may vary based on the number of versions of the browser. For example, for a browser with over 100 versions, the threshold may be 10 versions, and for a browser with fewer than 20 versions, the threshold may be 2 or 3 versions. The threshold number of versions may be specified with respect to browser versions and/or sub-versions. The browser validation module 216 may be further configured to automatically perform testing in the selected browser in response to validating the selected browser.

Browser launching module 218 may be configured to cause launching of each of the plurality of browsers in order to automatically perform parallel testing of the plurality of feature files and the plurality of runner files in the plurality of browsers.

Report generation module 220 may be configured to generate a testing report, or a modified testing report, including a browser name associated with test output from each of the respective parallel tests performed. Report generation module 220 may be configured to cause display of the generated testing report.

Report generation module 220 may be configured to report on the automated testing, for example by appending the browser name in front of the data to be reported. The system may be configured to modify a generated report to include the browser name.

Report generation module 220 may be configured to use browser configuration data, such as a browser tag, as a means to separate or segregate the test cases in a generated report. Without the browser tag, a reporting mechanism would not know what browser information is there. Report generation module 220 may be configured to cause generation of a testing report, or generate a testing report, or cause modification of a testing report, or modify a testing report. A browser tag may combine the browser name with parameters of the test. Without a browser tag, after generating a first set of data for a testing report, subsequent results may simply overwrite the first set of data since it may be presumed to be duplicate. Report generation module 220, by using a browser name in a testing report, enables a system to keep track of which browser information to update.

In some embodiments, computing platform(s) 202, remote platform(s) 204, and/or external resources 222 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 222 may be operatively linked via some other communication media.

A given remote platform 204 may include one or more processors configured to execute computer program modules. The computer program modules may be configured to enable an expert or user associated with the given remote platform 204 to interface with system 200 and/or external resources 222, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 222 may include sources of information outside of system 200, external entities participating with system 200, and/or other resources. In some embodiments, some or all of the functionality attributed herein to external resources 222 may be provided by resources included in system 200.

Computing platform(s) 202 may include electronic storage 224, one or more processors 226, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 224 may comprise non-transitory storage media that electronically stores information. The electronic storage media of electronic storage 224 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 224 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 224 may include one or more virtual storage resources (e.g., cloud storage, a virtual private network, and/or other virtual storage resources). Electronic storage 224 may store software algorithms, information determined by processor(s) 226, information received from computing platform(s) 202, information received from remote platform(s) 204, and/or other information that enables computing platform(s) 202 to function as described herein.

Processor(s) 226 may be configured to provide information processing capabilities in computing platform(s) 202. As such, processor(s) 226 may include one or more of a digital processor, an analog processor, a digital circuit designed to process information, an analog circuit designed to process information, a state machine, and/or other mechanisms for electronically processing information. Although processor(s) 226 is shown in FIG. 2 as a single entity, this is for illustrative purposes only. In some embodiments, processor(s) 226 may include a plurality of processing units. These processing units may be physically located within the same device, or processor(s) 226 may represent processing functionality of a plurality of devices operating in coordination. Processor(s) 226 may be configured to execute modules 208, 210, 212, 214, 216, 218 and/or 220, and/or other modules. Processor(s) 226 may be configured to execute modules 208, 210, 212, 214, 216, 218 and/or 220, and/or other modules by software; hardware; firmware; some combination of software, hardware, and/or firmware; and/or other mechanisms for configuring processing capabilities on processor(s) 226. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214, 216, 218 and/or 220 are illustrated in FIG. 2 as being implemented within a single processing unit, in embodiments in which processor(s) 226 includes multiple processing units, one or more of modules 208, 210, 212, 214, 216, 218 and/or 220 may be implemented remotely from the other modules. The description of the functionality provided by the different modules 208, 210, 212, 214, 216, 218 and/or 220 described below is for illustrative purposes, and is not intended to be limiting, as any of modules 208, 210, 212, 214, 216, 218 and/or 220 may provide more or less functionality than is described. For example, one or more of modules 208, 210, 212, 214, 216, 218, 220, 222, 224, and/or 226 may be eliminated, and some or all of its functionality may be provided by other ones of modules 208, 210, 212, 214, 216, 218 and/or 220. As another example, processor(s) 226 may be configured to execute one or more additional modules that may perform some or all of the functionality attributed below to one of modules 208, 210, 212, 214, 216, 218 and/or 220.

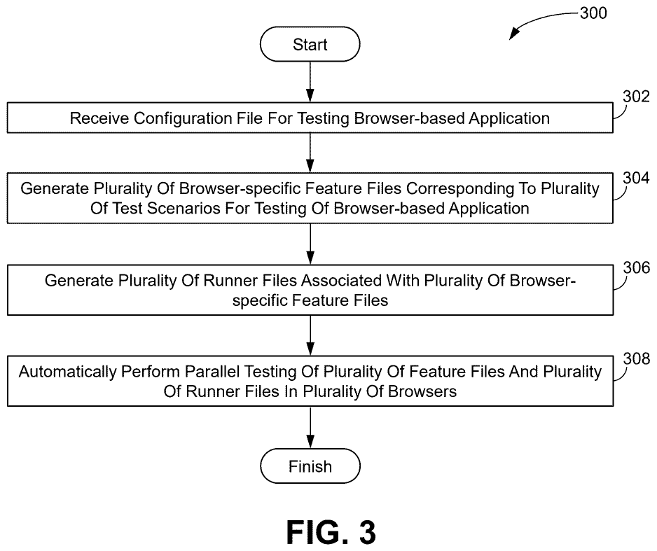

FIG. 3 illustrates a method 300 for software testing, in accordance with one or more embodiments. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 302 may include receiving a configuration file for testing a browser-based application. The configuration file may include browser configuration data associated with a plurality of browsers in relation to which the browser-based application is to be tested. Operation 302 may include generating the configuration file by obtaining and modifying a non-browser-specific configuration file to include the browser configuration data. Operation 302 may be performed by one or more hardware processors configured by machine-readable instructions including a module that is the same as or similar to configuration file management module 208, in accordance with one or more embodiments.

An operation 304 may include generating a plurality of browser-specific feature files corresponding to a plurality of test scenarios for the testing of the browser-based application. Each of the plurality of browser-specific feature files may include browser-specific parameters based on the browser configuration data. Operation 304 may be performed by one or more hardware processors configured by machine-readable instructions including a module that is the same as or similar to feature file generation module 210, in accordance with one or more embodiments.

An operation 306 may include generating a plurality of runner files associated with the plurality of browser-specific feature files. Operation 306 may be performed by one or more hardware processors configured by machine-readable instructions including a module that is the same as or similar to runner file generation module 212, in accordance with one or more embodiments.

An operation 308 may include automatically performing parallel testing of the plurality of feature files and the plurality of runner files in the plurality of browsers. Operation 308 may be performed by one or more hardware processors configured by machine-readable instructions including a module that is the same as or similar to parallel testing module 214, in accordance with one or more embodiments.

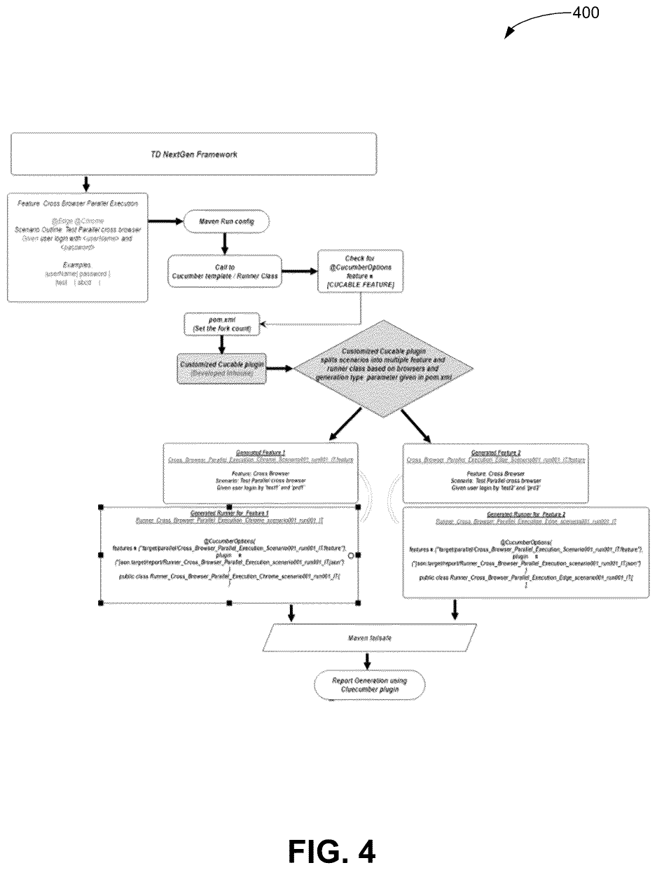

FIG. 4 illustrates a method for software testing with example outputs, in accordance with one or more embodiments. Based on a configuration file such as a project object model (POM) file, the system may obtain browser configuration data from the POM file, and split the scenarios into multiple feature and runner class files based on the browser name and scenario generation type parameters given in the POM file. FIG. 4 shows high-level examples of a generated Feature 1 file for cross browser execution in Chrome for user test1, and a related Runner file for Feature 1. FIG. 4 also shows high-level examples of a generated Feature 2 file for cross browser execution in Edge for user test2, and a related Runner file for Feature 2.

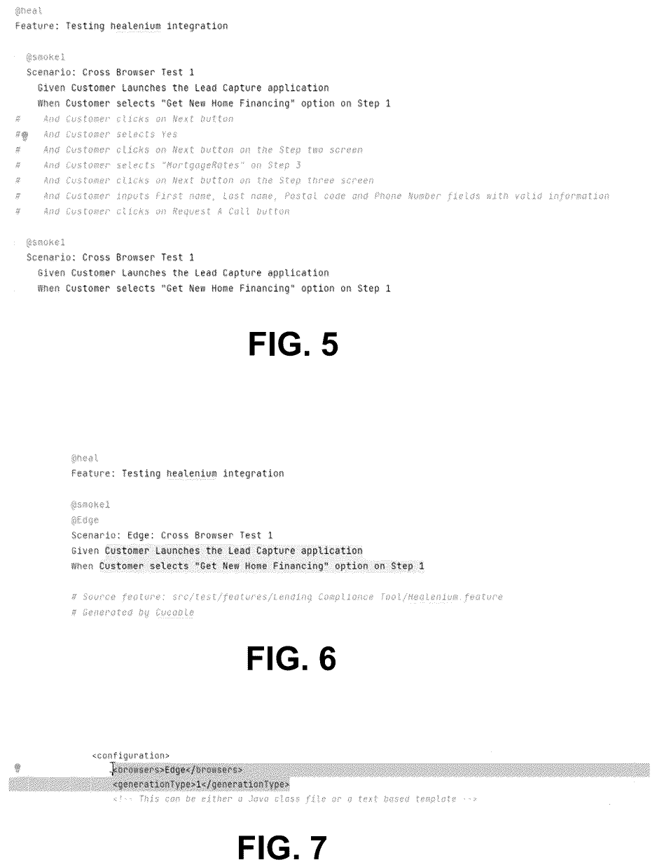

FIG. 5 illustrates example code for a feature file including two scenarios for test cases, in accordance with one or more embodiments. FIG. 5 illustrates example code for a feature file including two scenarios for test cases. The code in FIG. 5 includes two scenarios, which may be split up using a plugin such as the Cucable plugin, and may be generated by an apparatus 120 as in FIG. 1 or feature file generation module 210 as in FIG. 2.

FIG. 6 illustrates example code for a first single-scenario feature file including browser-specific parameters, in accordance with one or more embodiments. FIG. 6 illustrates example code for a first single-scenario feature file including browser-specific parameters according to an embodiment. The feature file of FIG. 6 includes browser configuration data. For example, FIG. 6 includes the tag @Edge which is a browser name tagged on the scenario file. When the code includes multiple tags, such as @Chrome, @Edge, the system will create multiple copies of the same scenario with different browser name tags. The system may be configured to read the browser name from the tagged scenario file, and launch the browsers in parallel, enabling automation of the parallel testing in multiple browsers and for multiple scenarios.

FIG. 7 is a project object model file illustrating browser configuration data, in accordance with one or more embodiments. The POM file in the example embodiment of FIG. 7 comprises browser configuration data, including a browser name, shown here as Edge, and a generation type, shown here as type 1. A system in accordance with one or more embodiments may be configured to read these two properties from the POM file. While an example with a POM file is described here, any other type of configuration file may be used. The configuration file may specify all of the types of browsers to be tested. During runtime, the system may be configured to automate running the tests by tagging these browser names onto the scenario.

Embodiments of the present disclosure provide a platform to automate concurrent testing of a browser application in parallel on a plurality of browsers, for example based on regression testing. Embodiments of the present disclosure may leverage a plugin to split an original feature file into a plurality of feature files for different browser testing scenarios including a browser name tag. Performing automated cross-browser testing in parallel saves time compared to performing the testing in series, and the automation saves time otherwise spent by quality engineers performing tasks.

Embodiments of the present disclosure may perform one or more modifications at the plugin level, where the plugin requires or uses the feature files. The browsers to be tested may comprise desktop based browsers and/or mobile browsers. The system may employ different tags for mobile and desktop browsers, using the same logic for reading tags and executing logic based on the tags.

Embodiments of the present disclosure provide an advantage of saving one or more of computing resources, memory resources and time. For example, multiple browser testing may take 15 hours if the testing is done in series according to known approaches, based on 5 hours of testing for each of 3 browsers. Using embodiments of the present disclosure, the testing may be performed in parallel and may only take 5 hours in parallel for testing the 3 browsers, providing a significant savings in time and resources. Embodiments of the present disclosure provide time savings, and energy savings in processing. Embodiments of the present disclosure may be used for testing up to N number of browsers, for example 20 different browsers, with the number of browsers only limited by available resources.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a compact disk read only memory (CD-ROM), digital versatile disk (DVD), Blu-ray Disc Read Only Memory (BD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

Embodiments of the disclosure can be described with reference to the following clauses, with specific features laid out in the dependent clauses:

One aspect of the present disclosure relates to a processor-implemented method for software testing. The method may include receiving a configuration file for testing a browser-based application, the configuration file comprising browser configuration data associated with a plurality of browsers in relation to which the browser-based application is to be tested. The method may include generating a plurality of browser-specific feature files corresponding to a plurality of test scenarios for the testing of the browser-based application, each of the plurality of browser-specific feature files comprising browser-specific parameters based on the browser configuration data. The method may include generating a plurality of runner files associated with the plurality of browser-specific feature files. The method may include automatically performing parallel testing of the plurality of feature files and the plurality of runner files in the plurality of browsers.

In some implementations of the system, the processor(s) may be configured to generate the plurality of browser-specific feature files by splitting, using a plugin, an original feature file into the same number of browser-specific feature files as the number of tagged browsers to be tested.

In some implementations of the system, the processor(s) may be configured to include the browser configuration data comprising a plurality of browser tags equal in number to the plurality of browsers.

In some implementations of the system, the processor(s) may be configured to include each of the plurality of browser tags comprising a browser name and test parameters for one of the plurality of test scenarios.

In some implementations of the system, the processor(s) may be configured to generate the configuration file by obtaining and modifying a non-browser-specific configuration file to include the browser configuration data.

In some implementations of the system, the processor(s) may be configured to validate a selected browser when the selected browser has a matching browser name and nonidentical browser version compared to the browser-specific parameters of at least one of the plurality of browser-specific feature files. In some implementations of the system, the processor(s) may be configured to automatically perform testing in the selected browser in response to validating the selected browser.

In some implementations of the system, the processor(s) may be configured to cause launching of each of the plurality of browsers in order to automatically perform parallel testing of the plurality of feature files and the plurality of runner files in the plurality of browsers.

In some implementations of the system, the processor(s) may be configured to generate the plurality of browser-specific feature files based on the browser configuration data including a browser name and a browser test generation type.

In some implementations of the system, the processor(s) may be configured to generate a testing report including a browser name associated with test output from each of the respective parallel tests performed. In some implementations of the system, the processor(s) may be configured to cause display of the generated testing report.

Another aspect of the present disclosure relates to a processor-implemented method for software testing. The method may include receiving a configuration file for testing a browser-based application, the configuration file comprising browser configuration data associated with a plurality of browsers in relation to which the browser-based application is to be tested. The method may include generating a plurality of browser-specific feature files corresponding to a plurality of test scenarios for the testing of the browser-based application, each of the plurality of browser-specific feature files comprising browser-specific parameters based on the browser configuration data. The method may include generating a plurality of runner files associated with the plurality of browser-specific feature files. The method may include automatically performing parallel testing of the plurality of feature files and the plurality of runner files in the plurality of browsers.

In some implementations of the method, it may include generating the plurality of browser-specific feature files by splitting, using a plugin, an original feature file into the same number of browser-specific feature files as the number of tagged browsers to be tested.

In some implementations of the method, the browser configuration data may comprise a plurality of browser tags equal in number to the plurality of browsers.

In some implementations of the method, each of the plurality of browser tags may comprise a browser name and test parameters for one of the plurality of test scenarios.

In some implementations of the method, it may include generating the configuration file by obtaining and modifying a non-browser-specific configuration file to include the browser configuration data.

In some implementations of the method, it may include validating a selected browser when the selected browser has a matching browser name and nonidentical browser version compared to the browser-specific parameters of at least one of the plurality of browser-specific feature files. In some implementations of the method, it may include automatically performing testing in the selected browser in response to validating the selected browser.

In some implementations of the method, it may include causing launching of each of the plurality of browsers in order to automatically perform parallel testing of the plurality of feature files and the plurality of runner files in the plurality of browsers.

In some implementations of the method, it may include generating the plurality of browser-specific feature files based on the browser configuration data including a browser name and a browser test generation type.

In some implementations of the method, it may include generating a modified testing report including a browser name associated with test output from each of the respective parallel tests performed. In some implementations of the method, it may include causing display of the modified testing report.

Yet another aspect of the present disclosure relates to a non-transient computer-readable storage medium having instructions embodied thereon, the instructions being executable by one or more processors to perform a method for software testing. The method may include receiving a configuration file for testing a browser-based application, the configuration file comprising browser configuration data associated with a plurality of browsers in relation to which the browser-based application is to be tested. The method may include generating a plurality of browser-specific feature files corresponding to a plurality of test scenarios for the testing of the browser-based application, each of the plurality of browser-specific feature files comprising browser-specific parameters based on the browser configuration data. The method may include generating a plurality of runner files associated with the plurality of browser-specific feature files. The method may include automatically performing parallel testing of the plurality of feature files and the plurality of runner files in the plurality of browsers.

In some implementations of the computer-readable storage medium, the method may include generating the plurality of browser-specific feature files by splitting, using a plugin, an original feature file into the same number of browser-specific feature files as the number of tagged browsers to be tested.

In some implementations of the computer-readable storage medium, the method may include the browser configuration data comprising a plurality of browser tags equal in number to the plurality of browsers.

In some implementations of the computer-readable storage medium, the method may include each of the plurality of browser tags comprising a browser name and test parameters for one of the plurality of test scenarios.

In some implementations of the computer-readable storage medium, the method may include generating the configuration file by obtaining and modifying a non-browser-specific configuration file to include the browser configuration data.

In some implementations of the computer-readable storage medium, the method may include validating a selected browser when the selected browser has a matching browser name and nonidentical browser version compared to the browser-specific parameters of at least one of the plurality of browser-specific feature files. In some implementations of the computer-readable storage medium, the method may include automatically performing testing in the selected browser in response to validating the selected browser.

In some implementations of the computer-readable storage medium, the method may include causing launching of each of the plurality of browsers in order to automatically perform parallel testing of the plurality of feature files and the plurality of runner files in the plurality of browsers.

In some implementations of the computer-readable storage medium, the method may include generating the plurality of browser-specific feature files based on the browser configuration data including a browser name and a browser test generation type.

In some implementations of the computer-readable storage medium, the method may include generating a modified testing report including a browser name associated with test output from each of the respective parallel tests performed. In some implementations of the computer-readable storage medium, the method may include causing display of the modified testing report.

Still another aspect of the present disclosure relates to a system configured for software testing. The system may include means for receiving a configuration file for testing a browser-based application, the configuration file comprising browser configuration data associated with a plurality of browsers in relation to which the browser-based application is to be tested. The system may include means for generating a plurality of browser-specific feature files corresponding to a plurality of test scenarios for the testing of the browser-based application, each of the plurality of browser-specific feature files comprising browser-specific parameters based on the browser configuration data. The system may include means for generating a plurality of runner files associated with the plurality of browser-specific feature files. The system may include means for automatically performing parallel testing of the plurality of feature files and the plurality of runner files in the plurality of browsers.

In some implementations of the system, the system may include means for generating the plurality of browser-specific feature files by splitting, using a plugin, an original feature file into the same number of browser-specific feature files as the number of tagged browsers to be tested.

In some implementations of the system, the system may include means wherein the browser configuration data comprises a plurality of browser tags equal in number to the plurality of browsers.

In some implementations of the system, the system may include means wherein each of the plurality of browser tags comprises a browser name and test parameters for one of the plurality of test scenarios.

In some implementations of the system, the system may include means for generating the configuration file by obtaining and modifying a non-browser-specific configuration file to include the browser configuration data.

In some implementations of the system, the system may include means for validating a selected browser when the selected browser has a matching browser name and nonidentical browser version compared to the browser-specific parameters of at least one of the plurality of browser-specific feature files. In some implementations of the system, the system may include means for automatically performing testing in the selected browser in response to validating the selected browser.

In some implementations of the system, the system may include means for causing launching of each of the plurality of browsers in order to automatically perform parallel testing of the plurality of feature files and the plurality of runner files in the plurality of browsers.

In some implementations of the system, the system may include means for generating the plurality of browser-specific feature files based on the browser configuration data including a browser name and a browser test generation type.

In some implementations of the system, the system may include means for generating a modified testing report including a browser name associated with test output from each of the respective parallel tests performed. In some implementations of the system, the system may include means for causing display of the modified testing report.

Even another aspect of the present disclosure relates to a computing platform configured for software testing. The computing platform may include a non-transient computer-readable storage medium having executable instructions embodied thereon. The computing platform may include one or more hardware processors configured to execute the instructions. The processor(s) may execute the instructions to receive a configuration file for testing a browser-based application, the configuration file comprising browser configuration data associated with a plurality of browsers in relation to which the browser-based application is to be tested. The processor(s) may execute the instructions to generate a plurality of browser-specific feature files corresponding to a plurality of test scenarios for the testing of the browser-based application, each of the plurality of browser-specific feature files comprising browser-specific parameters based on the browser configuration data. The processor(s) may execute the instructions to generate a plurality of runner files associated with the plurality of browser-specific feature files. The processor(s) may execute the instructions to automatically perform parallel testing of the plurality of feature files and the plurality of runner files in the plurality of browsers.

In some implementations of the computing platform, the processor(s) may execute the instructions to generate the plurality of browser-specific feature files by splitting, using a plugin, an original feature file into the same number of browser-specific feature files as the number of tagged browsers to be tested.

In some implementations of the computing platform, the processor(s) may execute the instructions wherein the browser configuration data comprises a plurality of browser tags equal in number to the plurality of browsers.

In some implementations of the computing platform, the processor(s) may execute the instructions wherein each of the plurality of browser tags comprises a browser name and test parameters for one of the plurality of test scenarios.

In some implementations of the computing platform, the processor(s) may execute the instructions to generate the configuration file by obtaining and modifying a non-browser-specific configuration file to include the browser configuration data.

In some implementations of the computing platform, the processor(s) may execute the instructions to validate a selected browser when the selected browser has a matching browser name and nonidentical browser version compared to the browser-specific parameters of at least one of the plurality of browser-specific feature files. In some implementations of the computing platform, the processor(s) may execute the instructions to automatically perform testing in the selected browser in response to validating the selected browser.

In some implementations of the computing platform, the processor(s) may execute the instructions to cause launching of each of the plurality of browsers in order to automatically perform parallel testing of the plurality of feature files and the plurality of runner files in the plurality of browsers.

In some implementations of the computing platform, the processor(s) may execute the instructions to generate the plurality of browser-specific feature files based on the browser configuration data including a browser name and a browser test generation type.

In some implementations of the computing platform, the processor(s) may execute the instructions to generate a testing report including a browser name associated with test output from each of the respective parallel tests performed. In some implementations of the computing platform, the processor(s) may execute the instructions to cause display of the generated testing report.

What is claimed is:

1. An apparatus configured for software testing, the apparatus comprising:
a non-transient computer-readable storage medium having executable instructions embodied thereon; and
one or more hardware processors configured to execute the instructions to:
receive a configuration file for testing a browser-based application, the configuration file comprising browser configuration data associated with a plurality of browsers in relation to which the browser-based application is to be tested;
generate a plurality of browser-specific feature files corresponding to a plurality of test scenarios for the testing of the browser-based application, each of the plurality of browser-specific feature files comprising browser-specific parameters based on the browser configuration data;
generate a plurality of runner files associated with the plurality of browser-specific feature files; and
automatically perform parallel testing of the plurality of feature files and the plurality of runner files in the plurality of browsers.

2. The apparatus of claim 1 wherein the one or more hardware processors are further configured to execute the instructions to:
generate the plurality of browser-specific feature files by splitting, using a plugin, an original feature file into the same number of browser-specific feature files as the number of tagged browsers to be tested.

3. The apparatus of claim 1 wherein the browser configuration data comprises a plurality of browser tags equal in number to the plurality of browsers.

4. The apparatus of claim 1 wherein each of the plurality of browser tags comprises a browser name and test parameters for one of the plurality of test scenarios.

5. The apparatus of claim 1 wherein the one or more hardware processors are further configured to execute the instructions to:
generate the configuration file by obtaining and modifying a non-browser-specific configuration file to include the browser configuration data.

6. The apparatus of claim 1 wherein the one or more hardware processors are further configured to execute the instructions to:
validate a selected browser when the selected browser has a matching browser name and nonidentical browser version compared to the browser-specific parameters of at least one of the plurality of browser-specific feature files; and
automatically perform testing in the selected browser in response to validating the selected browser.

7. The apparatus of claim 1 wherein the one or more hardware processors are further configured to execute the instructions to:
cause launching of each of the plurality of browsers in order to automatically perform parallel testing of the plurality of feature files and the plurality of runner files in the plurality of browsers.

8. The apparatus of claim 1 wherein the one or more hardware processors are further configured to execute the instructions to:
generate the plurality of browser-specific feature files based on the browser configuration data including a browser name and a browser test generation type.

9. The apparatus of claim 1 wherein the one or more hardware processors are further configured to execute the instructions to:
generate a testing report including a browser name associated with test output from each of the respective parallel tests performed; and
cause display of the generated testing report.

10. A method of software testing comprising:
receiving a configuration file for testing a browser-based application, the configuration file comprising browser configuration data associated with a plurality of browsers in relation to which the browser-based application is to be tested;
generating a plurality of browser-specific feature files corresponding to a plurality of test scenarios for the testing of the browser-based application, each of the plurality of browser-specific feature files comprising browser-specific parameters based on the browser configuration data;
generating a plurality of runner files associated with the plurality of browser-specific feature files; and
automatically performing parallel testing of the plurality of feature files and the plurality of runner files in the plurality of browsers.

11. The method of claim 10 further comprising:
generating the plurality of browser-specific feature files by splitting, using a plugin, an original feature file into the same number of browser-specific feature files as the number of tagged browsers to be tested.

12. The method of claim 10 wherein the browser configuration data comprises a plurality of browser tags equal in number to the plurality of browsers.

13. The method of claim 10 wherein each of the plurality of browser tags comprises a browser name and test parameters for one of the plurality of test scenarios.

14. The method of claim 10 further comprising:
generating the configuration file by obtaining and modifying a non-browser-specific configuration file to include the browser configuration data.

15. The method of claim 10 further comprising:
validating a selected browser when the selected browser has a matching browser name and nonidentical browser version compared to the browser-specific parameters of at least one of the plurality of browser-specific feature files; and
automatically performing testing in the selected browser in response to validating the selected browser.

16. The method of claim 10 further comprising:
causing launching of each of the plurality of browsers in order to automatically perform parallel testing of the plurality of feature files and the plurality of runner files in the plurality of browsers.

17. The method of claim 10 further comprising:
generating the plurality of browser-specific feature files based on the browser configuration data including a browser name and a browser test generation type.

18. The method of claim 10 further comprising:
generating a modified testing report including a browser name associated with test output from each of the respective parallel tests performed; and
causing display of the modified testing report.

19. A non-transient computer-readable storage medium having instructions embodied thereon, the instructions being executable by one or more processors to perform a method of software testing comprising:
receiving a configuration file for testing a browser-based application, the configuration file comprising browser configuration data associated with a plurality of browsers in relation to which the browser-based application is to be tested;
generating a plurality of browser-specific feature files corresponding to a plurality of test scenarios for the testing of the browser-based application, each of the plurality of browser-specific feature files comprising browser-specific parameters based on the browser configuration data;
generating a plurality of runner files associated with the plurality of browser-specific feature files; and
automatically performing parallel testing of the plurality of feature files and the plurality of runner files in the plurality of browsers.

20. The non-transient computer-readable storage medium of claim 19 wherein the method further comprises:
generating the plurality of browser-specific feature files by splitting, using a plugin, an original feature file into the same number of browser-specific feature files as the number of tagged browsers to be tested.
